(19) United States
(12) Patent Application Publication
(10) Pub. No.: US 2014/0215147 A1
(43) Pub. Date: Jul. 31, 2014

(54) RAID STORAGE REBUILD PROCESSING

(71) Applicant: HEWLETT-PACKARD DEVELOPMENT COMPANY, L.P., Houston, TX (US)

(72) Inventor: Weimin Pan, Spring, TX (US)

(73) Assignee: Hewlett-Packard Development Company, L.P., Houston, TX (US)

(21) Appl. No.: 13/750,896

(22) Filed: Jan. 25, 2013

(51) Int. Cl. G06F 11/00

(52) U.S. Cl. CPC G06F 11/004
USPC 711/114

(57) ABSTRACT

A storage management module configured to identify storage volumes to be rebuilt and remaining storage volumes that are not to be rebuilt, calculate rebuild priority information for the identified storage volumes to be rebuilt based on storage information of the identified storage volumes, and generate rebuild requests to rebuild the identified storage volumes to be rebuilt and process host requests directed to the remaining and to be rebuilt storage volumes based on the rebuild priority information and amount of host requests, wherein with relative high amount of host requests, generate relative less rebuild requests but not less than a minimum rebuild traffic percentage or more than a maximum rebuild traffic percentage.

### BACKGROUND

Storage devices, such as hard disk drives and solid state disks, can be arranged in various configurations for different purposes. For example, such storage devices can be configured to have different redundancy levels as part of a Redundant Array of Independent Disks (RAID) storage configuration. In such a configuration, the storage devices can be arranged to represent logical or virtual storage and to provide different performance and redundancy based on the RAID level.

### BRIEF DESCRIPTION OF THE DRAWINGS

Certain examples are described in the following detailed description and in reference to the drawings, in which:

FIG. 1 is an example block diagram of a storage system to provide RAID storage rebuild processing according to an example of the techniques of the present application.

FIG. 2 is an example process flow diagram of a method of RAID storage rebuild processing according to an example of the techniques of the present application.

FIG. 3 is another example process flow diagram of a method of RAID storage rebuild processing according to an example of the techniques of the present application.

FIG. 4 is an example block diagram showing a non-transitory, computer-readable medium that stores instructions for a method of RAID storage rebuild processing according to an example of the techniques of the present application.

### DETAILED DESCRIPTION OF SPECIFIC EXAMPLES

As explained above, storage devices, such as hard disk drives and solid state disks, can be arranged in various configurations for different purposes. For example, such storage devices can be configured to have different redundancy levels as part of a Redundant Array of Independent Disks (RAID) storage configuration. In such a configuration, the storage devices can be arranged to represent logical or virtual storage and to provide different performance and redundancy based on the RAID level. Redundancy of storage devices can be based on mirroring of data, where data in a source storage device is copied to a mirror storage device (which contains a mirror copy of the data in the source storage device). In this arrangement, if an error or fault causes data of the source storage device to be unavailable, then the mirror storage device can be accessed to retrieve the data.

Another form of redundancy is parity-based redundancy where actual data is stored across a group of storage devices, and parity information associated with the data is stored in another storage device. If data within any of the group of storage devices were to become inaccessible (due to data error or storage device fault or failure), the parity information from the other non-failed storage device can be accessed to rebuild or reconstruct the data. Examples of parity-based redundancy configurations such as RAID configurations, including RAID-5 and RAID-6 storage configurations. An example of a mirroring redundancy configurations is the RAID-1 configuration In RAID-3 and RAID-4 configurations, parity information is stored in dedicated storage devices. In RAID-5 and RAID-6 storage configurations, parity information is distributed across all of the storage devices. Although reference is made to RAID in this description, it is noted that some embodiments of the present application can be applied to other types of redundancy configurations, or to any arrangement in which a storage volume is implemented across multiple storage devices (whether redundancy is used or not). A storage volume may be defined as virtual storage that provides a virtual representation of storage that comprises or is associated with physical storage elements such as storage devices. For example, the system can receive host requests from a host to access data or information on storage volume where the requests include storage volume address information and then the system translates the volume address information into the actual physical address of the corresponding data on the storage devices. The system can then forward or direct the processed host requests to the appropriate storage devices.

When any portion of a particular storage device (from among multiple storage devices on which storage volumes are implemented) is detected as failed or exhibiting some other fault, the entirety of the particular storage device is marked as unavailable for use. As a result, all of the storage volumes may be unable to use the particular storage device. A fault or failure of a storage device can include any error condition that prevents access of a portion of the storage device. The error condition can be due to a hardware or software failure that prevents access of the portion of the storage device. In such cases, the system can implement a reconstruction or rebuild process that includes generating rebuild requests comprising commands directed to the storage subsystem to read the actual user data from the storage devices that have not failed and parity data from the storage devices to rebuild or reconstruct the data from the failed storage devices. In addition to the rebuild requests, the system also can process host requests from a host to read and write data to storage volumes that have not failed as well as failed, where such host requests may be relevant to performance of the system. The storage capacity of current storage subsystems may be increasing which may be causing rebuild time of a rebuild process of RAID storage volumes of storage systems to increase. It may be important for such systems to have the ability to balance the rebuild time or speed of the rebuild process with performance impact during the rebuild process.

The present application provides techniques to help balance the rebuild speed and performance impact during the rebuild process. In one example, techniques are disclosed to calculate rebuild priority of storage volumes having failed storage devices (also referred to as degraded storage volumes) to allow the system to help balance rebuild time and performance impact from the rebuild process. That is, the system may handle or process host requests from a host to read and write data to storage volumes and the higher the rate of the requests then the higher performance of the system while the rebuild process requires rebuild requests which take time to complete and which may impact system performance. The system provides techniques to dynamically adjust the rebuild priority to balance data loss probability and performance impact during the rebuild process. Such dynamic rebuild techniques may improve system performance compared to fixed rebuild priority techniques. The techniques may include methods to dynamically adjust the rebuild priority of the storage volumes based on current storage information such as fault tolerance of storage devices of the degraded storage volumes having failed storage devices, size or storage capacity of storage devices of the degraded storage volumes, health or condition of the remaining storage devices of degraded storage volumes, amount of total time spent on the rebuild process of the degraded storage volume and the like.

In one example, the present application provides techniques for generating rebuild requests for RAID storage volumes along with processing host requests based on the rebuild priority of the storage volumes. The system can assign rebuild priority to storage volumes, where the higher the rebuild priority, the higher the percentage of the rebuild requests generated along with outstanding host requests. The system can rebuild storage volumes having the highest relative rebuild priority volume first and then rebuild storage volumes with relative lower rebuild priority. If the system has a storage volume with a relative higher rebuild priority that requires to be rebuilt, then the system can halt or suspend the lower rebuild priority storage volume which is currently being rebuilt and start the rebuild process for the storage volume having the higher rebuild priority.

In accordance with some embodiments of the present application, techniques are provided to help balance the speed of the rebuild process with performance impact during the rebuild process. In one example, disclosed is a storage system to process storage that includes a storage subsystem and a storage controller having a storage management module. The storage subsystem can include a plurality of RAID storage volumes provided across storage devices. The storage management module can be configured to identify storage volumes to be rebuilt and remaining storage volumes that are not to be rebuilt. In one example, the storage management module can identify storage volumes to be rebuilt that include identification of storage devices that have a failed or have a failure status which may have been caused from an actual storage device failure, or a predictive failure status which may have been caused by storage errors that have not actual failure but may result in an actual failure in the future.

The storage management module can calculate rebuild priority information for the identified storage volumes to be rebuilt based on storage information of the identified storage volumes. In one example, the storage management module is configured to calculate rebuild priority information based on storage information that includes at least one of fault tolerance state based on RAID level of the storage volumes and the number of failed status storage devices, number of predictive failure status storage devices of storage volumes, estimated rebuild time to rebuild storage volumes, number of storage devices of that make comprise storage volumes, and type of storage devices of storage volumes. The storage management module can generate rebuild requests to rebuild the identified storage volumes to be rebuilt and process host requests from a host directed to the remaining and to be rebuilt storage volumes based on the rebuild priority information. In one example, the rebuild requests can include requests to rebuild data from non-failure storage devices of the identified storage volumes that including rebuilding the failed storage devices onto spare storage devices. The host requests can include requests to read data from storage devices of the remaining and to be rebuilt storage volumes and write data to storage devices of the storage volumes. In another example, the storage management module can adjust the number of rebuild requests based on host rebuild priority information and host requests.

These techniques may provide advantages to storage systems that encounter degraded storage volume conditions from failed storage devices of storage volumes. The techniques can automatically and dynamically calculate and adjust rebuild priority of storage volumes based on current system conditions. These techniques can help improve the fault tolerance protection of storage systems provided by RAID configurations and may help reduce performance impact on the system during the rebuild process. For example, in a system with a degraded storage volume with no further fault tolerance protection available, the system can increase the rebuild priority to start the rebuild process of the degraded storage volume regardless of host requests or activities which can help reduce possible user data loss of the degraded storage volume. On the other hand, in a system with a degraded storage volume which still has a certain level of fault tolerance protection available, the system can start the rebuild process of the degraded volume but while reducing or minimizing host performance impact during the rebuild process.

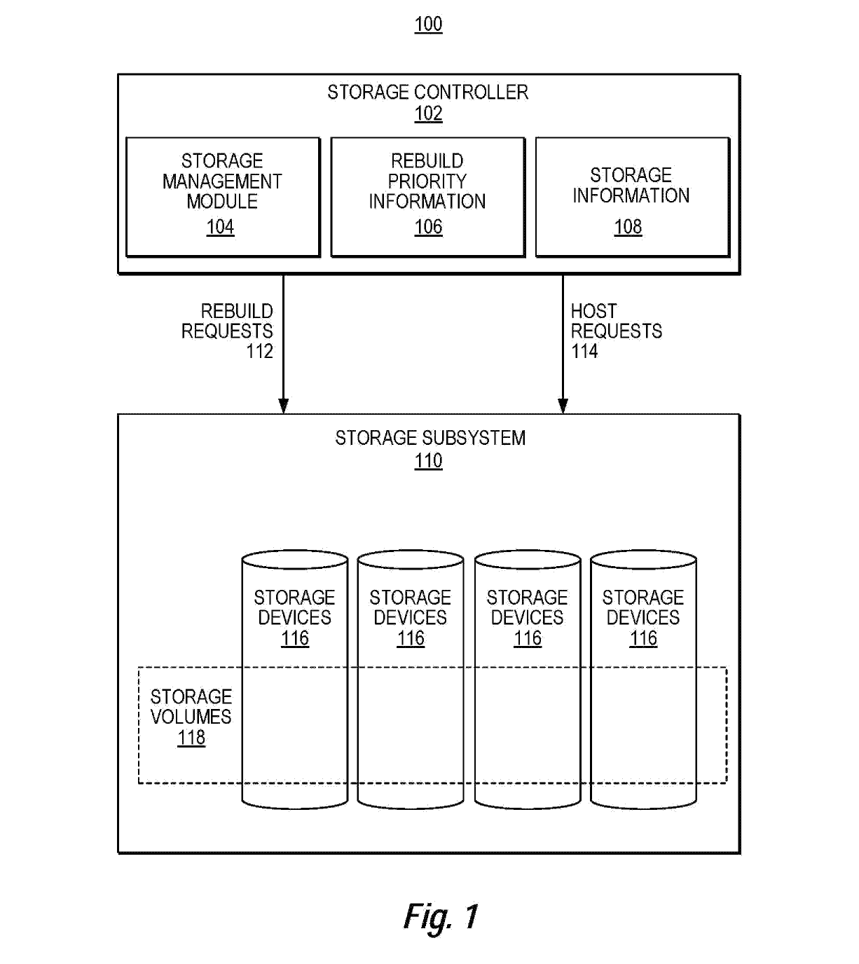

FIG. 1 shows a block diagram of a storage system 100 to provide RAID storage rebuild processing according to an example of the techniques of the present application. The storage system 100 includes a storage subsystem 110 communicatively coupled to storage controller 102 which is configured to control the operation of storage system. As explained below in further detail, in one example, storage controller 102 includes a storage management module 104 configured to calculate rebuild priority information 106 for storage volumes 118 that have failed and adjust the number of rebuild requests 112 directed to storage subsystem 110 to rebuild the failed storage volumes based on the number of host requests 114 and rebuild priority information to help balance rebuild time and performance.

The storage management module 104 can be configured to identify storage volumes 118 to be rebuilt and remaining storage volumes that are not to be rebuilt. In one example, storage management module 104 can identify storage volumes 118 to be rebuilt by identification of storage devices 116 that have failed or having a failed status caused from an actual storage device failure, or a predictive failure status caused from storage error that may result in an actual storage device failure in the future.

The storage management module 104 can be configured to calculate rebuild priority using rebuild priority information 106 for the identified storage volumes 118 to be rebuilt based on storage information 108 of the identified storage volumes. In one example, storage management module 104 can calculate rebuild priority information 106 based on storage information 108 that can include at least one of fault tolerance state based on RAID level of the storage volumes and the number of failed status storage devices. For example, storage management module 104 can check the current fault tolerance state or level of a RAID storage volume, and the higher the current state or level, the lower rebuild priority assigned to the storage volume. For example, a system having a RAID-6 storage volume without failed storage devices may have higher fault tolerance level than a system with RAID-5 storage volume without failed storage devices. A system with a RAID-6 storage volume with one failed storage device may have the same fault tolerance level as a system with a RAID-5 storage volume without failed storage devices. In other words, storage management module 104 may calculate a different rebuild priority for a single storage device failure in a RAID-6 storage volume compared to a single storage device failure in a RAID-5 volume because a single storage device failure in a RAID-6 storage volume may still exhibit fault tolerance but a single storage device failure in a RAID-5 storage volume may not exhibit fault tolerance.

In another example, storage management module 104 can calculate rebuild priority information 106 based on storage information 108 that can include the number of predictive failure status storage devices of storage volumes. As explained above, predictive failure or predicate status of a storage volume may be caused from storage error that may result in an actual storage device failure in the future. For example, the higher the number of predictive failure storage devices detected, the higher the rebuild priority of the storage volume. In one example, the rebuild priority of a dual storage device predictive failure of a RAID-5 storage volume may be higher than a single storage device predictive failure of a RAID-5 storage volume.

In another example, storage management module 104 can calculate rebuild priority information 106 based on storage information 108 that can include estimated rebuild time to rebuild storage volumes. In one example, the longer the rebuild time to rebuild a storage volume, the higher the rebuild priority assigned to the storage volume. If all other factors are the same, a storage volume with a large size or storage capacity from large capacity or numbers of storage devices may have a higher rebuild priority than a storage volume with a relatively size or storage capacity rebuild priority based in part because the rebuild process of the larger size storage volume may take a longer time that the rebuild process of the smaller size storage volume. In this case, system 100 with a large capacity storage volume may have exhibit a higher Mean Time Between Failure (MTBF) risk factor than a small capacity storage volume.

In another example, storage management module 104 can calculate rebuild priority information 106 based on storage information 108 that include number of storage devices of storage volumes and type of storage devices of storage volumes. For example, assuming that all other factors are the same, the higher the number of storage devices comprising storage volumes, the higher rebuild priority since the higher number of storage devices of storage volumes, the higher probability of storage device failure if the probability of a storage device failure is constant. The storage device type may be another consideration or factor. For example, failure probability of middle line Serial AT Attachment (SATA) storage devices may be higher than failure probability of enterprise Serial Attached Small Computer System Interface (SAS) storage devices, and therefore SATA storage devices may be assigned higher rebuild priority than SAS storage devices.

The storage management module 104 can generate rebuild requests 112 to rebuild the identified storage volumes to be rebuilt and process host requests 114 to the remaining and to be rebuilt storage volumes based on the rebuild priority information. In one example, rebuild requests 112 can include requests or commands to rebuild data from non-failed storage devices of the identified storage volumes to spare storage devices. In another example, host requests 114 can include requests or commands to read data from storage devices of storage volumes and write data to storage devices of storage volumes. In another example, storage management module 104 can adjust the number of rebuild requests 112 based on host rebuild priority information 108 and number of host requests 114, as explained below in further detail.

In one example, storage management module 104 can assign storage volumes 118 a minimum rebuild traffic percentage and a maximum rebuild traffic percentage based on associated rebuild priority information, and then assign a relative high minimum rebuild traffic percentage to storage volumes with relative high rebuild priority information. In another example, storage management module 104 can assign storage volumes 118 a minimum rebuild traffic percentage and a maximum rebuild traffic percentage based on associated rebuild priority information, wherein with relative high host requests 114, then generate relative less rebuild requests but not less than the assigned storage volume minimum rebuild traffic percentage or more than the assigned maximum rebuild traffic percentage For example, storage management module 104 can assign a minimum rebuild traffic percentage value of 20% to a dual failure device RAID-6 storage volume and minimum rebuild traffic percentage value of 10% to a single failure drive RAID-6 storage volume. The maximum rebuild traffic percentage in both cases can be set to a value of 100%. In operation, to illustrate, when system 100 experiences little or no host traffic from host requests 114, the system can set the rebuild traffic percentage to the maximum rebuild traffic percentage to a value of 100%. In operation, when storage system 100 experiences relatively high or heavy host traffic, the dual failure storage devices of RAID-6 storage volume can cause the system to generate 20% rebuild traffic from rebuild requests 112 and the single failure drive RAID-6 storage volume can cause the system to generate 10% rebuild traffic from rebuild requests. That is, a dual failure storage device of a RAID-6 storage volume rebuild process may be performed about twice as fast than the rebuild process of a single failure storage device of a RAID-6 storage volume.

In another example, storage management module 104 can provide different rebuild priority schemes to storage volumes 118 from rebuild priority information 106. For example, storage management module 104 can provide a low priority, medium priority, and high priority configuration or scheme. To illustrate low rebuild priority, storage management module 104 can assign a low rebuild priority to a degraded storage volume 118 as a result of failed storage devices 116 and then generate rebuild requests 112 when there is little or no host activity from host requests 114. In this case, system 100 may experience little or no host performance impact but the rebuild process may take the longest time to complete if there is much host activity from host requests 114. In another example, to illustrate medium rebuild priority, storage management module 104 can assign a medium rebuild priority to a degraded storage volume 118 as a result of failed storage devices 116 and then generate rebuild requests 112 but only process the requests during system idle processing time such as during idle processor cycles. In this case, system 100 may experience reduced or minimum host performance impact but the system may allow the rebuild process to continue to progress even if there is high host activity from host requests 114. To illustrate a high rebuild priority, storage management module 104 can assign a high rebuild priority to a degraded storage volume 118 that has failed storage devices 116 and then generate a particular percentage of rebuild requests 112, such as no less than 50%, along with processing host requests 114 from host activities. In other words, the lower the amount of host requests 114 from low host activity, the higher the percentage of rebuild requests 112. The storage management module 104 can generate rebuild requests 112 requiring a particular rebuild time independent or no matter the amount of host activity from host requests 114.

In another example, storage management module 104 can dynamically adjust rebuild priority based on certain storage information 108 of degraded storage volumes. The storage information 108 can include information of degraded storage volumes 118 and associated storage devices 116 such as the current condition of a degraded storage volume, fault tolerance of a degraded storage volume, size or storage capacity of degraded storage volume, health of remaining non-failed storage devices of degraded storage volumes, the amount of the rebuild process has taken or completed, and the like as explained above. For example, if a degraded storage volume 118 with failed storage devices 116 has no fault tolerance remaining as a result of storage device failures (such as a RAID-5 storage volume or a RAID-1/RAID-10 storage volume), then storage management module 104 can set the rebuild priority of the degraded storage volume to a high rebuild priority. On the other hand, if a degraded storage volume still has fault tolerance remaining (such as in a RAID-6 storage volume or RAID-1/RAID-10-NWay with a single storage device) and storage management module 104 detects predicative storage failure, then the storage management module can set the rebuild priority of the storage volume to a high rebuild priority value. Furthermore, if the size or storage capacity of the degraded storage volume is relatively large, then storage management module 104 can set the rebuild priority to a medium value, otherwise the storage management module can set the rebuild priority to a low value. The storage management module 104 can generate rebuild requests 112 along with processing host requests 114 based on storage volume rebuild priority 106. In one example, the higher the rebuild priority of a storage volume, storage management module 104 can generate a higher percentage of rebuild requests 112 along with processing host requests 114. The storage management module 104 can be configured to initiate a rebuild process for a storage volume 113 with the highest rebuild priority first. If there is a higher rebuild priority storage volume requiring to be rebuilt, storage management module 104 can stop or suspend a lower priority storage volume rebuild process which is currently being rebuilt and start or initiate the higher rebuild priority storage volume rebuild process.

The storage controller 102 can be communicatively coupled to storage subsystem 110 using communication means such as communication links to allow for exchange of data or information such as transmission of rebuild requests 112 and host requests 114 and responses thereto. For example, the communication links can be any means of communication such as SCSI links, a SAS links, Fibre Channel links, Ethernet and the like. The storage controller 102 can be connected to a network (e.g., local area network, storage area network, or other type of network) to allow client computers to access the storage controller. The storage controller 102 can communicate with host devices such as client computers which can issue host requests to read and write data and rebuild request to rebuild failed storage volumes, or other input/output (I/O) requests over a network to the storage controller. In response to such requests, storage controller 102 can access storage subsystem 110 to perform the requested accesses. The host devices such as client computers can be user computers, or alternatively, the client computers can be server computers that are accessible by user computers.

The storage subsystem 110 include be configured to provide virtual storage to hosts through the use of storage volumes 118 which can be defined by storage devices 116. In one example, storage management module 104 can configure storage volumes 118 as a first storage volume and a second storage volume, where one storage volume can be defined across storage devices 116, or more than two volumes can be defined across the storage devices. Although both two storage volumes are defined across the same set of storage devices, it should be understood that in an alternative implementation, the first storage volume can be implemented across a first collection or group of storage devices, and the second storage volume can be implemented across a second collection or group of storage devices. The storage volumes 118 can be defined as RAID volumes such as RAID-1, RAID-5, or RAID-6 storage volumes and the like.

The storage devices 116 can include physical storage elements, such as a disk-based storage element (e.g., hard disk drive, optical disk drive, etc.) or other types of storage element (e.g., semiconductor storage element). The storage devices 116 within storage subsystem 110 can be arranged as an array, in some exemplary implementations. More generally, storage subsystem 110 can include collection of storage devices 116, where such collection of storage devices can be contained within an enclosure (defined by an external housing of the storage subsystem). Alternatively, storage devices 116 of storage subsystem 110 can be located in multiple enclosures.

The storage management module 104 can be configured to check or monitor for faults associated with storage subsystem 110. The faults associated with storage subsystem 110 can include failure or other faults of individual ones of storage devices 116 associated or defined as part of storage volumes. In one example, in response to detection of a fault of any particular storage devices 116, storage management module 16 can determine which part(s) of the storage device has failed. The storage devices 116 can experience faults for various reasons. For example, a physical component of the storage device may fail, such as failure of a power supply, failure of a mechanical part, failure of a software component, failure of a part of storage media, and so forth. Some of the component failures above can cause the entire storage device to become inaccessible, in which case the storage device has experienced a total failure. On the other hand, some other failures may cause just a localized portion of the storage device to become inaccessible

The storage management module 104 can be configured to manage the operation of storage subsystem 110. In one example, storage management module 104 can include functionality to configure storage subsystem 110 as RAID configurations such as a RAID-6 configuration with a dual redundancy level with a first storage volume and a second storage volume with each of the storage volumes having six storage devices. The storage management module 104 can check for failures of storage devices of the first storage volume that may result in the storage volume having at least two fewer redundant devices as compared to the second storage volume. A failure of a storage device can include a failure condition such that at least a portion of content of a storage device is no longer operational or accessible by storage management module 104. In contrast, storage devices may be considered in an operational or healthy condition when the data on the storage devices are accessible by storage management module 104. The storage management module 104 can check any one of storage volumes which may have encountered a failure of any of associated storage devices. In one example, a failure of storage devices can be caused by data corruption which can cause the corresponding storage volume to no longer have redundancy, in this case, no longer have dual redundancy or a redundancy level of two.

The storage management module 104 can be configured to perform a process to handle failure of storage devices 116 of storage volumes 118. For example, storage management module 104 check whether a storage volume 118 encounters failure of associated storage devices 116 such that the failure causes the storage volume to no longer have redundancy. In such case where the storage volume no longer has a redundancy level of two (dual redundancy), then storage management module 104 can proceed to perform a rebuild process to handle the storage device failure. For example, storage management module 104 can perform a process to first select a spare storage device for use by the failed storage device of the storage volume. The storage management module 104 can then rebuild data from the failed storage devices onto the selected spare storage device.

The system 100 is shown as a storage controller 102 communicatively coupled to storage subsystem 110 to implement the techniques of the present application. However, the techniques of the application can be employed with other configurations. For example, storage controller 102 can include any means of processing data such as, for example, one or more server computers with RAID or disk array controllers or computing devices to implement the functionality of the components of the storage controller such as storage management module 104. The storage controller 102 can include computing devices having processors configured to execute logic such as processor executable instructions stored in memory to perform functionality of the components of the storage system 100 as storage management module 104. In another example, storage controller 102 and storage subsystem 110 may be configured as an integrated or tightly coupled system. In another example, storage system 100 can be configured as a JBOD (just a bunch of disks or drives) combined with a server computer and an embedded RAID or disk array controller configured to implement the functionality of storage management module 104 and the techniques of the present application.

In another example, storage system 100 can be configured as an external storage system. For example, storage system 100 can be an external RAID system with storage subsystem 110 configured as a RAID disk array system. The storage controller 102 can include a plurality of hot swappable modules where each of the modules can include RAID engines or controllers to implement the functionality of storage management module 104 and the techniques of the present application. The storage controller 102 can include functionality to implement interfaces to communicate with storage subsystem 110 and other devices. For example, storage controller 102 can communicate with storage subsystem 110 using a communication interface configured to implement communication protocols such as SCSI, Fibre Channel and the like. The storage controller 102 can include a communication interface configured to implement protocols, such as Fibre Channel and the like, to communicate with external networks including storage networks such as Storage Area Network SAN, Network Attached Storage (NAS) and the like. The storage controller 102 can include functionality to implement interfaces to allow users to configure functionality of system 100 including storage management module 104, for example, to allow users to configure the RAID redundancy of storage subsystem 110. The functionality of the components of storage system 100, such as storage management module 104, can be implemented in hardware, software or a combination thereof.

In addition to having storage controller 102 configured to handle storage failures, it should be understood that the storage controller is capable of performing other storage related functions or tasks. For example, storage management module 104 can be configured to respond to requests, from external systems such as host computers, to read data from storage subsystem 110 as well as write data to the storage subsystem and the like. As explained above, storage management module 104 can configure storage subsystem 110 as a multiple redundancy RAID storage system. In one example, storage volumes 118 of storage subsystem 110 can be configured as a RAID-6 system with a plurality of storage volumes each having storage devices configured with block level striping with double distributed parity. The storage management module 104 can implement block level striping by dividing data that is to written to storage as data blocks that are stripped or distributed across multiple storage devices. The stripe can include a set of data extending across the storage devices such as disks. In one example, data can be written to extents which may represent portions or pieces of a stripe on disks or storage devices. In another example, data can be written in terms of storage volumes. For example, if a portion of a storage device fails, then storage management module 104 can rebuild a portion of the volume or disk rather than rebuild or replace the entire storage device or disk.

In addition, in another example, storage management module 104 can implement double distributed parity by calculating parity information of the data that is to be written to storage and then writing the calculated parity information across two storage devices. In another example, storage management module 104 can write data to storage subsystem 110 in portions called extents or segments. In addition, parity information may be calculated based on the data to be written, and then the parity information may be written to the storage devices. In case of a double parity arrangement, a first parity set can be written to the storage device and another set of the parity set may be written to another storage device. In this manner, data may be distributed across multiple storage devices to provide a multiple redundancy configuration. In one example, storage management module 104 can store the whole stripe of data in memory and then calculate the double parity information (sometimes referred to as P and Q).

In another example, storage management module 104 can support spare storage devices which can be employed as replacement storage drives during the rebuild process to replace failed storage devices and rebuild the data from the failed storage devices. For example, a spare storage device can be designated as a standby storage device and can be employed as a failover mechanism to provide reliability in storage system configurations. The spare storage device can be an active storage device coupled to storage subsystem 110 as part of storage system 100. For example, if storage device of a storage volume encounters a failure condition, then storage management module 104 may be configured to start a rebuild process to rebuild the data from the failed storage device to the spare storage device. In one example, storage management module 104 can read data from the non-failed storage device of a degraded storage volume, calculate the parity information and then store or write this information to the spare storage device.

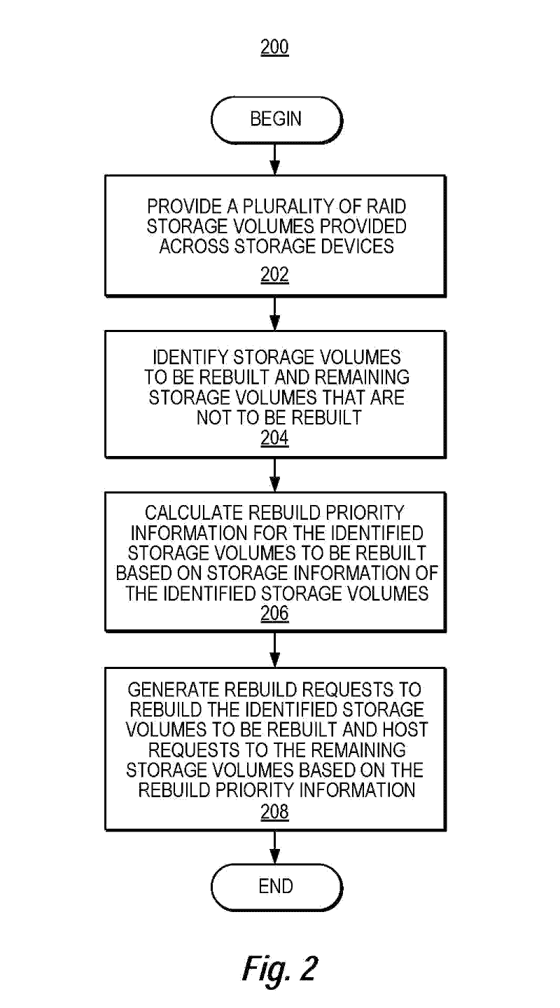

FIG. 2 is an example process flow diagram 200 of a method of RAID storage rebuild processing according to an example of the techniques of the present application. In one example, to illustrate, it can be assumed that storage system 100 of FIG. 1 is used to implement the techniques of the present techniques such as flow diagram 200.

The method may begin at block 202, where storage controller 102 provides a plurality of RAID storage volumes provided or defined across storage devices. In one example, to illustrate, it can be assumed that storage controller 102 can configure storage subsystem 110 as RAID-6 storage volumes defined with a plurality of storage devices for user data and dual parity storage devices to store parity information of the user data. In one example, storage management module 104 can configure storage volumes 118 as a RAID-6 configuration with a first storage volume 118 with associated storage devices 116 and a second storage volume with associated storage devices. During normal operation, storage management module 104 can process host requests 112 from a host directed to read data from and write data to storage volumes 118 such as first and second storage volumes.

At block 204, storage controller 102 Identifies storage volumes to be rebuilt and remaining storage volumes that are not to be rebuilt. In one example, to illustrate, it can be assumed that the first storage volume encounters storage failures of the corresponding or assigned storage devices of the storage volume. In this case, storage management module 104 detects such storage failures and sets the status of the first storage volume to indicate a failed or failure status which the storage management module interprets as a need to begin a rebuild process to rebuild the failed storage volume. It can be assumed that the second storage volume has not encountered storage failures of the corresponding storage devices. In this case, storage management module 104 detects this condition and sets the status of the second storage volume to indicate a non-failed status which the storage management module interprets that it is not necessary to begin a rebuild process for this storage volume.

It can be assumed that the above example was for illustrative purpose and that other examples can be employed to illustrate the techniques of the present application. For example, the second storage volume could have encountered storage failures or both storage volumes could have encountered storage failures, or other storage volume combinations. In addition, a different number of storage volumes could have been employed. In another example, storage management module 104 is configured to detect an actual storage device failure such as in the first storage volume described above. In addition, storage management module 104 can be configured to detect predicative storage failures of storage volumes. For example, storage devices of storage volumes may encounter data errors which may result in future storage failures. In this case, storage management module 104 can set the status of the corresponding storage volume to indicate a predicative failure status which the storage management module can interpret as a need to begin a rebuild process to rebuild this storage volume, though it has not yet actually failed. In this manner, storage management module 104 can anticipate storage failures and begin the rebuild process before the occurrence of actual storage failures.

At block 206, storage controller 102 calculates rebuild priority information 106 for the identified storage volumes 118 to be rebuilt based on storage information 108 of the identified storage volumes. To illustrate, continuing with the above example, where the first storage volume is set to a failed status, storage management module 104 can proceed to calculate rebuild priority information 106 based on storage information 108 that includes at least one of fault tolerance state based on RAID level of the storage volumes and the number of failed status storage devices, as explained above. In one example, to illustrate, it can be assumed that the first storage volume was configured as a RAID-6 storage volume arrangement and that both of the parity storage devices failed. In such a case, storage management module 104 can consider the fault tolerance state based on RAID level of the storage volumes and the number of failed status storage devices. In this case, the fault tolerance of the first storage volume is zero because both of the parity storage devices failed. Therefore, storage management module 104 can assign a relative high rebuild priority to the first storage volume.

At block 208, storage controller 102 generates rebuild requests 112 to rebuild the identified storage volumes to be rebuilt and process host requests 114 to the remaining storage volumes based on the rebuild priority information. In another example, storage controller 102 can process host requests 114 from a host and forward the requests directed to the remaining and to be rebuilt storage volumes. In one example, rebuild requests 112 can include requests to rebuild data from non-failure storage devices of the identified storage volumes to spare storage devices. In this case, storage management module 104 can generate rebuild requests 112 to rebuild the first storage volume that include generating requests to read data from the non-failed storage devices and parity information from the storage devices and to rebuild to spare storage devices. The host requests 114 can include requests to read data from storage devices of storage volumes and write data to storage devices of storage volumes that have not failed such as the second storage volume. In addition, host requests 114 can include requests to read data from storage devices of storage volumes and write data to storage devices of storage volumes that have failed such as the first storage volume. In another example, storage management module 104 can adjust the number of rebuild requests 112 based on rebuild priority information 106 and the number host requests 114. In this case, storage management module 104 assigned a high priority to rebuild the first storage volume. With the first storage volume being a degraded storage volume with no further fault tolerance protection available, storage management module 104 can increase the rebuild priority to start the rebuild process of the degraded storage volume regardless of host requests or activities which can help reduce possible user data loss of the degraded storage volume. In another example, if the first storage volume was identified as a degraded storage volume which still had a certain level of fault tolerance protection available, storage management module 104 could start the rebuild process of the degraded volume but while reducing or minimizing host performance impact during the rebuild process.

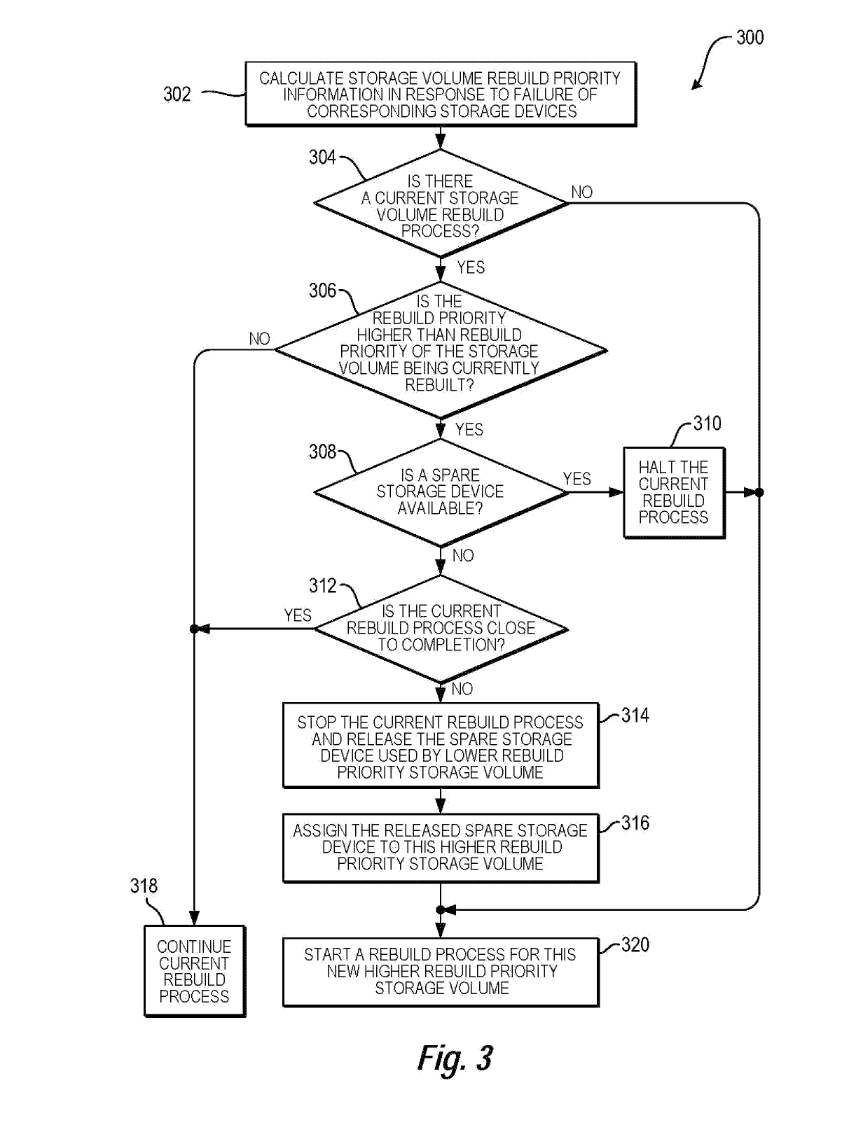

FIG. 3 is another example process flow diagram 300 of a method of RAID storage rebuild processing according to an example of the techniques of the present application. The example process flow will illustrate the techniques of the present application including processing failures in storage volumes configured as RAID storage volume arrangements.

At block 302, storage controller 102 calculates storage volume 118 rebuild priority information 106 in response to failure of corresponding storage devices 116. As explained above, in one example, to illustrate, storage management module 104 can calculate rebuild priority information 106 based on storage information 108 that includes at least one of fault tolerance state based on RAID level of the storage volumes and the number of failed status storage devices. To illustrate, it can be assumed that storage management module 104 used storage information 108 and in particular information about the current fault tolerance state based on the RAID level and the number of failed devices. That is, the higher the current fault tolerance level of the degraded storage volume, the lower the rebuild priority of the storage volume. For example, a RAID-6 storage volume without failed storage devices may have higher fault tolerance level than a RAID-5 storage volume without failed storage devices. A RAID-6 storage volume with one failed storage device may have the same fault tolerance level as a RAID-5 storage volume without failed devices. In other words, storage management module 104 may calculate different a rebuild priority for a single storage device failure in a RAID-6 storage volume compared to a single device failure in a RAID-5 volume because a single device failure in a RAID-6 storage volume may still exhibit fault tolerance but a single device failure in a RAID-5 storage volume may not exhibit fault tolerance. Processing proceeds to block 304 below for further processing.

At block 304, storage controller 102 checks whether there is a current storage volume rebuild process in progress. In one example, to illustrate operation, it can be assumed that storage management module 104 detected a storage device failure in a storage volume and proceeded to initiate a rebuild process to rebuild this first degraded storage volume. Then, storage management module 104 detected a storage device failure in a second, different degraded storage volume. In this case, processing proceeds to block 306 where storage management further 104 evaluates rebuild priority information 106 of the first degraded storage volume compared to the rebuild priority information of the second degraded storage volume. On the other hand, if there is only a failure of a single storage volume and no current rebuild process in progress or initiated, then processing proceeds to block 320 where storage management module 104 may initiate a rebuild process in response to the failure of the single degraded storage volume.

At block 306, storage controller 102 checks whether the rebuild priority is higher than rebuild priority of the storage volume being currently rebuilt. In one example, to illustrate operation, it can be assumed that storage management module 104 detected a storage device failure in a first storage volume and proceeded to initiate a rebuild process to rebuild this first degraded storage volume. Then, storage management module 104 detected a storage device failure in second, different degraded storage volume. The storage management module 104 then assigned a higher rebuild priority to the first degraded storage volume and a lower rebuild priority to the second degraded storage volume. In this case, processing proceeds to block 318 to have storage management module 104 continue with the rebuild process of the first storage volume because the rebuild priority of the first storage volume being current rebuilt is higher than the rebuild priority of the new second degraded storage volume. On the other hand, in a system with the reverse condition where the rebuild priority of the first degraded storage volume is lower than rebuild priority the second degraded storage volume, processing proceeds to block 308 below to have storage management module 104 determine whether a spare storage device is available for the rebuild process.

At block 308, storage controller 102 checks whether a spare storage device is available. In one example, storage management module 104 checks whether a second spare storage device is available for use in a rebuild process of the second degraded storage volume while the first degraded storage volume is currently being rebuilt to a first spare storage device. If a second spare storage device is available, then processing proceeds to block 310 to have storage management module 104 halt or suspend the rebuild process of the first storage volume. On the other hand, if a second spare storage device is not available, then processing proceeds to block 312 where storage management 104 checks whether the current rebuild process of the first storage volume is close to completion.

At block 310, storage controller 102 halts the current rebuild process. In one example, to illustrate, storage management modules 104 proceeds to halt or suspend the current rebuild process of the first storage volume. Processing then proceeds to block 320, where storage management module 104 starts a rebuild process for the second storage volume which has a higher rebuild priority.

At block 312, storage controller 102 checks whether the current rebuild process is close to completion. In one example, to illustrate, storage management module 104 can provide a variable that indicates percent complete (completion percentage) of the rebuild process. For example, if the percent complete is set to a value of 50%, and if the current rebuild process is more than 50% complete, then processing proceeds to block 318 where storage management module 104 continues with the current rebuild process. On the other hand, if the current rebuild process is less than 50% complete, then processing proceeds to block 314 where storage management module 104 handles the current rebuild process.

At block 314, storage controller 102 stops the current rebuild process and releases the spare storage device used by the lower rebuild priority storage volume. In one example, to illustrate operation, it can be assumed that storage management module 104 detected a storage device failure in a storage volume and proceeded to initiate a rebuild process to rebuild this first degraded storage volume. Then, storage management module 104 detected a storage device failure in a second, different degraded storage volume. It can be further assumed that the rebuild priority of the second degraded storage volume is higher than the rebuild priority of the first degraded storage volume currently being rebuilt. In this case, storage management module 104 can stop the current rebuild process of the first storage volume and release the spare storage device used by lower rebuild priority storage volume. Processing then proceeds to block 316 for further processing.

At block 316, storage controller 102 assigns the released spare storage device to this higher rebuild priority storage volume. Continuing with the above example, to illustrate operation, storage management module 104 halted or stopped the current rebuild process of the first storage volume and released the spare storage device used by this lower rebuild priority storage volume. In this case, storage management module 104 assigns the released spare storage device to the new higher rebuild priority storage volume, in this case, the second storage volume. Processing proceeds to block 320 where storage management proceeds to start the rebuild process for this new higher rebuild priority storage volume, in this case, the second storage volume.

At block 318, storage controller 102 continues the current rebuild process. Continuing with the above example of block 306, to illustrate operation, storage management module 104 detected a storage device failure in a first storage volume and proceeded to initiate a rebuild process to rebuild this first degraded storage volume. In this case, storage management module 104 continues with the rebuild process of the first storage volume. Once processing in block 318 is complete, in one example, processing can proceed back to block 302 to have storage management module 104 continue to monitor for storage volumes that may have failed and to calculate rebuild priority for the failed storage volumes.

At block 320, storage controller 102 starts a rebuild process for this new higher rebuild priority storage volume. Continuing with the above example, to illustrate operation, storage management module 104 proceeds to start or initiate the rebuild process for the new higher rebuild priority storage volume, in this case, the second storage volume. Once the rebuild process has been initiated, in one example, processing can proceed back to block 302 to have storage management module 104 continue to monitor for storage volumes that may have failed and to calculate rebuild priority for the failed storage volumes.

The above techniques may provide advantages to storage systems that encounter degraded storage volume conditions from failed storage devices of storage volumes. The techniques can be configured to automatically and dynamically calculate and adjust rebuild priority of storage volumes based on current system conditions. These techniques can help improve the fault tolerance protection of storage systems provided by RAID storage volume configurations and may help reduce performance impact on the system during the rebuild process. For example, in a system with a degraded storage volume with no further fault tolerance protection available, the system can increase the rebuild priority to start the rebuild process of the degraded storage volume regardless of host requests or activities which can help reduce possible user data loss of the degraded storage volume. On the other hand, in a system with a degraded storage volume which still has certain level of fault tolerance protection available, the system can start the rebuild process of the degraded volume but while reducing or minimizing host performance impact during the rebuild process.

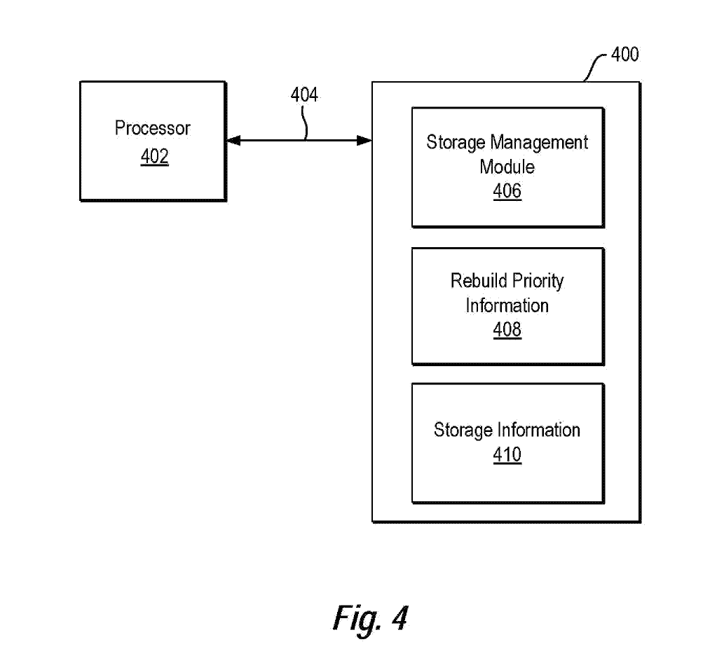

FIG. 4 is an example block diagram showing a non-transitory, computer-readable medium that stores instructions for a method of RAID storage rebuild processing according to an example of the techniques of the present application. The non-transitory, computer-readable medium is generally referred to by the reference number 400 and may be included in storage system described in relation to FIG. 1. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, Electrically Erasable Programmable Read Only Memory (EEPROM) and Read Only Memory (ROM). Examples of volatile memory include, but are not limited to, Static Random Access Memory (SRAM), and Dynamic Random Access Memory (DRAM). Examples of storage devices include, but are not limited to, hard disk drives, compact disc drives, digital versatile disc drives, optical drives, solid state drives and flash memory devices.

A processor 402 generally retrieves and executes the instructions stored in the non-transitory, computer-readable medium 400 to operate the storage device in accordance with an example. In an example, the tangible, machine-readable medium 400 can be accessed by the processor 402 over a bus 404. A first region 406 of the non-transitory, computer-readable medium 400 may include functionality to implement storage management module as described herein. A second region 408 of the non-transitory, computer-readable medium 400 may include functionality to implement rebuild priority information as described herein. A third region 410 of the non-transitory, computer-readable medium 400 may include functionality to implement storage information as described herein.

Although shown as contiguous blocks, the software components can be stored in any order or configuration. For example, if the non-transitory, computer-readable medium 400 is a hard drive, the software components can be stored in non-contiguous, or even overlapping, sectors.

What is claimed is:

1. A redundant array of independent disks (RAID) storage system comprising:
a storage controller with a storage management module to:
identify storage volumes to be rebuilt and remaining storage volumes that are not to be rebuilt,
calculate rebuild priority information for the identified storage volumes to be rebuilt based on storage information of the identified storage volumes, and
generate rebuild requests to rebuild the identified storage volumes to be rebuilt and process host requests directed to the remaining and to be rebuilt storage volumes based on the rebuild priority information and amount of host requests, wherein with relative high amount of host requests, generate relative less rebuild requests but not less than a minimum rebuild traffic percentage or more than a maximum rebuild traffic percentage.

2. The storage system of claim 1, wherein the storage management module is further configured to calculate rebuild priority information based on storage information that includes at least one of fault tolerance state based on RAID level of the storage volumes and the number of failed status storage devices, number of predictive failure status storage devices of storage volumes, estimated rebuild time to rebuild storage volumes, number of storage devices of storage volumes, and type of storage devices of storage volumes.

3. The storage system of claim 1, wherein the storage management module is further configured to generate rebuild requests that include requests to rebuild data from non failure storage devices of the identified storage volumes to spare storage devices.

4. The storage system of claim 1, wherein the storage management module is further configured to process host requests that include to process host requests from a host to read data from storage devices of storage volumes and write data to storage devices of storage volumes.

5. The storage system of claim 1, wherein the storage management module is further configured to identify storage volumes to be rebuilt include to identify storage devices of the storage volumes that have a failed status or a predictive failure status.

6. The storage system of claim 1, wherein the storage management module is further configured to adjust number of rebuild requests based on rebuild priority information and host requests.

7. The storage system of claim 1, wherein the storage management module is further configured to assign storage volumes a minimum rebuild traffic percentage and a maximum rebuild traffic percentage based on associated rebuild priority information, and to assign a relative high minimum rebuild traffic percentage to storage volumes with relative high rebuild priority information.

8. The storage system of claim 1, wherein if amount complete of a first priority rebuild is less than a completion percentage, stop the first priority rebuild and start a second priority rebuild having a higher priority than the first rebuild otherwise continue with the first priority rebuild.

9. A method for processing storage, the method comprising:
identifying, by a storage management module, storage volumes to be rebuilt and remaining storage volumes that are not to be rebuilt;
calculating, by the storage management module, rebuild priority information for the identified storage volumes to be rebuilt based on storage information of the identified storage volumes; and
generating, by the storage management module, rebuild requests to rebuild the identified storage volumes to be rebuilt and processing host requests directed to the remaining and to be rebuilt storage volumes based on the rebuild priority information and amount of host requests, wherein with relative high amount of host requests, generating relative less rebuild requests but not less than a minimum rebuild traffic percentage or more than a maximum rebuild traffic percentage.

10. The method of claim 9, wherein the storage management module further configured for calculating rebuild priority information based on storage information that includes at least one of fault tolerance state based on RAID level of the storage volumes and the number of failed status storage devices, number of predictive failure status storage devices of storage volumes, estimated rebuild time to rebuild storage volumes, number of storage devices of storage volumes, and type of storage devices of storage volumes.

11. The method of claim 9, wherein the storage management module is further configured for generating rebuild requests that include requests for rebuilding data from non failure storage devices of the identified storage volumes to spare storage devices.

12. The method of claim 9, wherein the storage management module is further configured for processing host requests that include processing host requests from a host for reading data from storage devices of storage volumes and writing data to storage devices of storage volumes.

13. The method of claim 9, wherein the storage management module is further configured for adjusting number of rebuild requests based on rebuild priority information and host requests.

14. The method of claim 9, wherein the storage management module is further configured for generating rebuild requests and host requests to include assigning storage volumes a minimum rebuild traffic percentage and a maximum rebuild traffic percentage based on associated rebuild priority information, and to assign a relative high minimum rebuild traffic percentage to storage volumes with relative high rebuild priority information.

15. A non-transitory computer-readable medium having computer executable instructions stored thereon to process storage, the instructions are executable by a processor to:
identify storage volumes to be rebuilt and storage volumes that are not to be rebuilt;
calculate rebuild priority information for the identified storage volumes to be rebuilt based on storage information of the identified storage volumes; and
generate rebuild requests to rebuild the identified storage volumes to be rebuilt and process host requests directed to the remaining and to be rebuilt storage volumes based on the rebuild priority information and amount of host requests, wherein with relative high amount of host requests, generate relative less rebuild requests but not less than a minimum rebuild traffic percentage or more than a maximum rebuild traffic percentage.

16. The non-transitory computer readable medium of claim 15, further comprising instructions to cause the processor to calculate rebuild priority information based on storage information that includes at least one of fault tolerance state based on RAID level of the storage volumes and the number of failed status storage devices, number of predictive failure status storage devices of storage volumes, estimated rebuild time to rebuild storage volumes, number of storage devices of storage volumes, and type of storage devices of storage volumes.

17. The non-transitory computer readable medium of claim 15, further comprising instructions to cause the processor to rebuild requests that include requests to rebuild data from non failure storage devices of the identified storage volumes to spare storage devices.

18. The non-transitory computer readable medium of claim 15, further comprising instructions to cause the processor to process host requests that include to process host requests from a host to read data from storage devices of storage volumes and write data to storage devices of storage volumes.

19. The non-transitory computer readable medium of claim 15, further comprising instructions to cause the processor to adjust number of rebuild requests based on rebuild priority information and host requests.

20. The non-transitory computer readable medium of claim 15, further comprising instructions to cause the processor to assign storage volumes a minimum rebuild traffic percentage and a maximum rebuild traffic percentage based on associated rebuild priority information, and to assign a relative high minimum rebuild traffic percentage to storage volumes with relative high rebuild priority information.
